(19) United States
(12) Patent Application Publication
(10) Pub. No.: US 2026/0367306 A1
(43) Pub. Date: Nov. 19, 2026

(54) LUMINOUS GLAZING UNIT

(71) Applicant: SAINT-GOBAIN SEKURIT FRANCE, THOUROTTE (FR)

(72) Inventors: Corentin MONMEYRAN, AUBERVILLIERS (FR); Nariaki SAKAI, AUBERVILLIERS (FR); Mathieu BERARD, AUBERVILLIERS (FR)

(21) Appl. No.: 19/144,165

(22) PCT Filed: Dec. 21, 2023
(86) PCT No.: PCT/FR2023/052089

§ 371 Date: Jun. 27, 2025

(30) Foreign Application Priority Data
Dec. 27, 2022 (FR) FR2214524

(51) Int. Cl. F21V 8/00; B32B 3/26; B32B 17/10

(52) U.S. Cl. CPC G02B 6/0073; B32B 3/266; B32B 17/10036; B32B 17/10229; B32B 17/10458; B32B 17/10541; G02B 6/0021; G02B 6/0023; G02B 6/0051; G02B 6/0093; B32B 2307/42

(57) ABSTRACT

A luminous glazing unit includes a first substrate coated with a functional coating, the first substrate including two faces and an edge face; a light source including an emitting surface optically coupled to the substrate such that the light enters the first substrate through an input face and the first substrate forms a light guide; a light extractor element for extracting the light and forming a light pattern; and at least one light polarizer located between the emitting surface of the light source and the face through which the light enters the substrate.

### TECHNICAL FIELD OF THE INVENTION

The technical field of the invention is that of luminous or illuminating glazing units. A luminous glazing is a glazing that emits light. It comprises a light source and a substrate comprising on one of its main faces a light-extracting element such as a patterned diffusing layer. The light source is optically coupled to the substrate, for example via the wafer. Light injected at the substrate edge propagates into the substrate by total internal reflection. The substrate acts as a light guide. We therefore refer to the “guided mode”.

The invention finds a particularly advantageous application in the creation of vehicle or building glazing units.

### INTRODUCTION

According to the present invention, light propagation in the substrate by total internal reflection is referred to as the “guided mode”. The guided mode thus corresponds to the use of grazing-incidence light inside a substrate. The critical parameter for the guided mode is the critical angle of total internal reflection. It corresponds to the angle relative to the normal to the substrate above which any light ray arriving on a separating surface or interface, from a medium with a higher optical index towards a medium with a lower optical index, is completely reflected by said surface or interface. The critical angle (θc) is determined by applying the Snell-Descartes equation. It corresponds to the angle (in the substrate) at which the light ray is refracted at 90° (in the medium of lower index than the substrate).

For luminous glazings, the surrounding medium may be air, another substrate or a polymeric interlayer. For example, the critical angle of total internal reflection at the interface between a glass substrate with a refractive index of 1.51 and the air is around 40°. In the case of a glass/polyvinyl butyral (PVB) polymer interlayer interface, the critical angle is around 80°.

All the light rays injected into the substrate that have an angle of incidence:
above this critical angle are reflected and continue to propagate in the substrate,
below this critical angle are partially refracted and gradually leave the substrate.

In the case of luminous glazing, the light sources used are preferably inorganic light-emitting diodes (LEDs, as opposed to OLEDs). Light is extracted at the extracting layer, forming a light pattern.

### TECHNOLOGICAL BACKGROUND OF THE INVENTION

It is known practice to incorporate inorganic light-emitting diodes, also referred to as LEDs, into the edge of single- or laminated glazing units so that the light emitted by the diodes enters via the edge face of a sheet of glass and is guided thereby as far as a diffusing element, also referred to as a light-extracting layer. Reference may be made to patent application WO2010049638.

These luminous glazing units have an essentially ambient-lighting or luminous signaling function which is obtained using low-power diodes. The lighting efficiency of such edge-illuminated glazing units is generally limited because of the light losses caused by the absorption of the light by the glass acting as a waveguide and/or the materials in the close vicinity thereof.

It is also known practice, in particular from documents WO 2013/110885 and WO 2018/178591, to drill a hole in the sheet of glass and fit the diodes therein. This hole is made near to the extraction means, in particular so as to shorten the optical path followed by the light between the diodes and the extraction means. In this way it is possible to reduce the losses associated with the absorption of the light.

The light emitted by the diodes is injected into the sheet of glass via an additional edge face formed by the hole. The light then bounces back and forth between the two main faces of the sheet of glass until it reaches the extractor element.

These luminous glazing units do not feature a functional coating (low-emissivity, anti-solar or absorbent).

There are many applications where the glazing unit has a functional coating. In the following description, the term “functional” means “capable of controlling solar radiation and/or infrared radiation”.

The coating may have a low-emissivity, absorbing or solar control function.

The “low-E” function or property refers to a glazing's ability to inhibit heating while reflecting infrared radiation. To this end, functional coatings with infrared (IR) radiation reflection properties are used.

The “solar control” function or property corresponds to a glazing unit's ability to reduce the amount of heat generated by solar radiation, while maximizing the amount of visible light. This ability is also provided by adding a functional coating to the glazing unit that reflects infrared radiation, on the same principle as the low-emissivity function.

Glazing units with functional coatings are used both for automotive applications, such as car roofs, and for building applications.

There is a growing demand for luminous glazing units. They can be single, double or laminated glazing units.

Another type of coating that can act on solar radiation is a functional coating comprising a layer that absorbs visible light.

Examples of IR-reflective functional coatings are those comprising a conductive oxide layer between two dielectric coatings, as described in patent application WO2018/206236. This application discloses, starting from the substrate, functional coatings comprising:
a dielectric coating comprising dielectric layers such as silicon nitride and/or silicon oxide layers,
a functional layer based on a transparent conductive oxide (TCO), such as a layer based on indium tin oxide (ITO),
a dielectric coating comprising dielectric layers such as silicon nitride and silicon oxide layers.

The absorption of visible light by the conductive oxide-based functional layers of these functional coatings is non-negligible, particularly in the red. However, the absorption of visible light at normal incidence remains low, as the light passes perpendicularly through the conductive oxide functional layer. The interaction between the radiation and the functional layer takes place only on the thickness of the functional layer.

The situation is different for guided-mode light. As explained above, light propagation in the substrate by total internal reflection is referred to as the “guided mode”.

When the functional coatings are placed close to the substrate in which the light propagates in guided mode, the light propagating in the substrate is likely to interact with the functional layer. The interaction angles between the light of the guided mode and the substrate are defined directly in the substrate into which light is injected. The rays of the guided mode are therefore largely “grazing” (θ greater than) 80° with respect to the normal to the substrate in which they propagate.

A guided mode ray therefore passes through the functional layer over a distance corresponding to: Functional layer thickness (ef)/cos (θ). The steeper the angle, the lower the cos (θ), the greater the distance over which the guided mode rays interact with the functional layer, and therefore the greater the proportion of absorbed rays.

In conclusion, when the substrate in which the light propagates comprises or is in contact with a functional coating, a significant portion of the light comes into contact with this functional coating at a grazing angle and is therefore likely to be absorbed when the functional coating comprises absorbing layers.

This is why, depending on the light injected, there is an alteration, a chromatic change, a reduction or even an erasure of the pattern as one moves away from the point of light injection due to the high guided mode absorption of the functional layer at grazing angles.

This problem is particularly acute at long visible wavelengths, as the absorption by the conductive oxide layers, and ITO in particular, increases with wavelength. In the case of luminous glazings, the guided-mode optical properties of the functional coating are therefore decisive.

This phenomenon is not limited to functional coatings comprising conductive oxide layers, but can also occur for other functional coatings, such as absorbent or solar control coatings.

When using light sources emitting red light (red LEDs), the guided absorption of red wavelengths results in a color (or brightness) that fades along the pattern (when moving away from the light source). When using light sources that emit white light, guided-mode absorption of red wavelengths results in fading color and brightness that dims along the pattern.

### SUMMARY OF THE INVENTION

The present invention seeks to overcome at least one of the disadvantages which have just been mentioned.

According to the invention, this objective is achieved by providing a luminous glazing unit comprising:
a first substrate with a functional coating (5), said substrate having two faces and an edge face (8);
a light source (7) comprising an emitting surface, optically coupled with the substrate so that light enters the substrate via an input face and the substrate forms a light guide;
a light-extracting element (6) for extracting light and forming a light pattern; the glazing unit being characterized in that it comprises at least one light polarizer located between the emitting surface of the light source (7) and the light input face in the substrate.

This is the guided mode, wherein the light injected into the substrate propagates through the substrate by total internal reflection, forming a guided light beam.

A polarizer is an optical instrument well known to those skilled in the art. It filters a preferential polarization direction from an incident light wave. The polarizer comes, for example, in the form of a semi-transparent plastic film or sheet. Polarizers are available on the market, for example from Techspec or 3M.

Within the context of the invention, the term “transparent” means that the transmission of light in the visible domain is greater than 50%. However, in applications wherein visibility through the glazing unit is not a key factor, the transmission of light may be far lower, for example greater than 5%.

Throughout the description and in the claims, what is meant by “substantially orthogonal” is an angle comprised between 85° and 95°.

According to one embodiment of the invention, the light input face into the substrate is the substrate edge face (8).

According to another embodiment of the invention, the substrate has a hole and the light input face into the substrate is a wall delimiting the hole.

Preferably, the light source (7) is an inorganic light-emitting diode (LED).

In the illuminating glazing unit of the present invention, a great many diodes preferably, for example at least three and preferably at least five and more preferentially still at least ten diodes, are positioned facing the light input face (or faces) of the waveguide.

The input face may be:
spaced from the polarizer, in particular by several centimeters, by no more than 10 mm, no more than 5 mm or no more than 1 mm, or
in optical contact with the polarizer by means of glue, or
in physical contact with the polarizer.

The polarizer may be:
spaced from the light-emitting surface, in particular by several centimeters, by no more than 10 mm, no more than 5 mm or no more than 1 mm, or
in optical contact with the emitting surface, by means of glue, or
in physical contact with the emitting surface.

According to preferred embodiments of the invention, the polarizer (9) is bonded to the emitting surface of the light source (7) or bonded to the light input face of the substrate.

According to a preferred embodiment of the invention, the substrate is coated with a low-emissivity functional coating (5), in particular comprising a transparent conductive oxide layer. Such conductive layers are known as TCO (“transparent conductive oxide”), and can be composed of indium tin oxide (ITO), fluorine-doped tin oxide or antimony-doped tin oxide.

According to one embodiment of the invention, the polarizer is an S-type polarizer.

According to another embodiment of the invention, the polarizer is a P-type polarizer.

The type of polarizer, S or P, must be chosen according to the coating present on the substrate.

According to a particular embodiment, the coating has low-emissivity properties, for example a coating with a TCO layer, and the polarizer is type S.

According to one embodiment, the luminous glazing unit is a single-glazed unit.

According to a preferred embodiment of the invention, the luminous glazing unit is laminated. It further comprises a second substrate (10, 20) and a lamination interlayer (30), in particular made of PVB, arranged between the two substrates to form a laminated glazing unit, the different faces of the substrates being numbered from 1 to 4 from the outside toward the inside of the passenger compartment or building.

Conventionally, the faces of a glazing are designated starting from the exterior by numbering the faces of the substrates from the outside toward the inside of the passenger compartment or of the premises which it equips. This means that the incident sunlight passes through the faces in increasing numerical order.

In the case of a laminated glazing unit, all the faces of the substrates are numbered from 1 to 4, but the faces of the laminating interlayers are not numbered. The first coated substrate (10) is located further inside the building or passenger compartment than the second substrate.

In the case of a laminated glazing according to the invention, it comprises a face 1 on the outside of the building or vehicle it equips, faces 2 and 3 in contact with the lamination interlayer and a face 4 on the inside of the building or vehicle. The functional coating is preferably positioned on face 4.

The extractor element (6) is preferably arranged on face 3 or 4, and even more preferably on face 3.

In the case of laminated glazing unit according to the invention, the light input face into the substrate (10) is preferably the edge face (8) of the substrate coated with the functional coating (5).

According to another embodiment of the invention, the glazing unit further comprises a second glass substrate, spaced apart from the first by a gas gap so as to form a double-glazed unit.

The invention also relates:
to a luminous glazing unit according to the invention mounted on a vehicle or on a building, and
to the use of a luminous glazing unit according to the invention as low-E glazing for buildings or vehicles,
to a building or vehicle comprising a glazing unit according to the invention.

The luminous glazing unit according to the invention is preferably an automotive glazing unit, such as an automotive roof glazing. The luminous glazing of the invention can be selected from a side window, rear window, roof window or windscreen.

The light source can be linear, such as a diode array.

The light source can be coupled directly to the substrate material or via a guide, collimation optics.

The light source is preferably optically coupled to the substrate of the material according to the invention. The optical coupling can be:
via the edge of the substrate of the material of the invention,
via a wall delimiting a hole, preferably a through-hole, in the substrate of the material, or
via light redirection, for example, the source can be located on side F4 (offset or opposite face F4) and a light redirection element such as a reflective prismatic film is positioned on face F3.

The light source capable of emitting light is preferably a light-emitting element such as a light-emitting diode (LED).

The light source can be polychromatic (white light) or monochromatic (red light).

According to the invention, when a polarizer is used, the power of the light source facing the polarizer is reduced, in particular by a factor of almost 2. There are several ways to compensate for this loss of power. One possibility is to double the number of LEDs used.

White LEDs are generally obtained by combining three LEDs of primary colors: red+green+blue. According to the invention, it might be possible to manufacture “white” LED lamps comprising twice as many LEDs of the color that is absorbed in the guided mode, and to place polarizers only opposite these LEDs presenting the color that is absorbed in the guided mode. For example, in the case of a functional coating based on red-absorbing conductive oxide in guided mode, the number of red diodes could be doubled, and each coupled to a polarizer.

The light source can be located opposite or close to the edges of the substrate to be coupled through the substrate edge. Reference may be made to patent application WO2010049638.

The light source can also be placed in a hole made in the glazing (circular or oblong). Reference may be made to patent applications WO2013110885 or WO2018178591.

The light source can be located close by, for example on face 4 (offset or opposite face 4), and a light redirection element such as a reflective prismatic film is positioned to redirect the light (for example on face 3). Reference may be made to patent application WO2022096365.

Several light sources can be used, for example near opposite edges of the substrate.

The diode or diodes may be top-emitting LEDs or side-emitting LEDs.

The diode or diodes are preferably on a diode carrier such as an electronic circuit board, for example a printed circuit board (PCB)

The diode carrier is preferably common to several diodes. The diode carrier may be opaque, for example being covered with a layer of lacquer or of paint, and may even conceal the diodes. It may comprise a substrate made of a plastic.

When the light input face into the substrate is the wall of a hole, the diode carrier with side-emitting diodes may follow the overall shape of the hole and have one main face attached to the bottom of the through-hole, directly or indirectly, for example via a mounting carrier. The diode carrier common to several side-emitting diodes may be a disk (or may be oblong) or a ring in the circular (or oblong) hole.

According to one embodiment, the diodes are powered with electricity by means of a current supply incorporated into the laminated glazing unit. For example, an electric wire may be incorporated into the lamination interlayer.

The substrates can be made of mineral glass or transparent polymer material. The substrates are preferably made of mineral glass.

The mineral glass substrates that make up the glazing can be soda-lime, aluminosilicate or borosilicate glass.

Substrates can be made of transparent polymeric material, including poly(methyl methacrylate) (PMMA), polycarbonate (PC), polyurethane or polyurea (PU) or polyethylene terephthalate (PET) substrates.

Preferably, the first substrate is made of a colorless soda-lime glass such as clear glass or extra clear glass like Planiclear® marketed by the Applicant Company. In the case of a single-glazing unit, the first substrate is preferably made of glass and has a thickness preferably comprised between 1 mm and 6 mm. In the case of a laminated glazing unit, the thickness of the first substrate preferably made of glass is preferably comprised between 0.6 mm and 3.2 mm, and more preferentially between 1.4 mm and 2.2 mm.

The second substrate may of course be as transparent and as colorless as the first substrate. According to one particular embodiment, a laminated glazing unit according to the invention is made up of two colorless Planiclear® substrates.

According to another embodiment, the second substrate is made of tinted glass, for example of tinted glass in particular having a light absorption of greater than 10%, such as Venus®, TSA3+ or TSA4+, also marketed by the Applicant Company. The second substrate has a thickness preferably comprised between 1.4 mm and 2.1 mm.

The luminous glazing unit according to the invention may be curved.

Preferably, the laminating interlayers comprise one or more sheets of organic polymers. Organic polymers are selected from polyvinyl butyral (PVB), polyurethanes (PU), polyureas, ethylene vinyl acetate (EVA), polyolefins (including polyethylene (PE), polypropylene (PP) or polyisobutylene (P-IB)), polyvinyl chloride and its derivatives (for example, polyvinyl dichloride (PVDC)), styrenic polymers (for example, polystyrene (PS), acrylostyrene butadiene (ABS), styrene acrylonitrile (SAN)), polyacrylics (including polyacrylonitrile (PAN) and poly(methyl methacrylate) (PMMA)), polyesters (including poly(ethylene terephthalate) (PET) and poly(butylene terephthalate) (PBT)), polyoxymethylene (POM), polyamides (PA), fluoropolymers such as polychlorotrifluoroethylene (PCTFE), polycarbonates (PC), aromatic polysulfones including polysulfone (PSU), polyphenylene ethers (PPE), epoxies (EP) alone or in blends and/or copolymers of several of these. The lamination interlayer may be tinted.

The lamination interlayer is preferably between 0.2 mm and 1.1 mm thick. Preferably, the lamination interlayer is transparent.

The lamination interlayer may be colorless or tinted.

The invention comprises a light-extracting element, preferably a patterned diffusing layer element. The diffusing layer element can be an enamel in contact with the substrate or formed on the face of a luminous glazing substrate by a surface treatment such as sandblasting, acid etching, or diffusing layer deposition. The extractor element (6) can be a diffusing, layered element, in particular a patterned enamel.

Acid-etched frosted glass, Satinovo® glass by SAINT-GOBAIN GLASS and glass with Smoothlite® diffusing coating by SAINT-GOBAIN GLASS are examples of layered diffusing elements.

In the case of laminated glazings, the layered diffusing element can be formed in the bulk of a substrate or interlayer, for example by laser etching. The layered diffusing element in the form of a substrate or interlayer is then applied to the surface of the substrate of the material according to the invention, for example by lamination.

The layered diffusing element can be placed on the substrate of the material according to the invention, in particular on the side opposite that of the functional coating.

In a laminated glazing unit, the functional coating is preferably on face 4 and the diffusing element on face 3. According to another embodiment, the functional coating can be on face 3 and the diffusing element on face 4. Finally, if certain applications call for outdoor lighting, the coating and the diffusing element can each be located on face 1 or 2.

The layered diffusing element can be a self-supporting diffusing film, preferably bonded to a glazing substrate.

The layered diffusing element can be a layer deposited on a substrate. The coating can be based on a diffusing enamel. It can be deposited discontinuously on one side of a substrate to form a pattern. The layer can be a diffusing ink printed on a substrate or an interlayer.

The diffusing layer may comprise an organic or inorganic matrix and diffusing particles of, for example, metal oxide such as titanium dioxide. An example of a mineral transparent diffusing layer is transparent enamel as described in application FR3084355. An example of an organic transparent diffusing layer is transparent layer as described in application WO2022023638.

The diffusing elements are positioned at the desired light extraction points. In this way, light can be directed onto the glazing surface, diffusing it by means of diffusing surfaces with well-defined areas and contours, according to geometric or even text patterns, for example.

The layered diffusing element can be opaque or transparent.

The layered diffusing element may comprise a matrix (organic or mineral) and diffusing particles, for example of metal oxide (TiO2, etc.).

An example of a mineral transparent diffusing layer is transparent enamel as described in application FR3084355.

An example of an organic transparent diffusing layer is transparent layer as described in application WO2022023638.

The preferred features which appear in the remainder of the description are applicable as well to the material according to the invention as, where appropriate, to the glazing, the method, the use, the building or the vehicle according to the invention.

All the described light features are obtained according to the principles and methods of the ISO 9050 standard relating to the determination of the light and solar features of the glazings used in glass for the construction industry.

Conventionally, the refractive indices are measured at a wavelength of 550 nm.

According to the invention:
light reflection corresponds to the reflection of solar radiation in the visible part of the spectrum,
light transmission corresponds to the transmission of solar radiation in the visible part of the spectrum,
light absorption corresponds to the absorption of solar radiation in the visible part of the spectrum.

### BRIEF DESCRIPTION OF THE FIGURES

The invention and its various applications will be better understood from reading the following description and examining the accompanying FIGURE:

FIG. 1 is a schematic depicted of a luminous laminated glazing unit according to one embodiment of the invention.

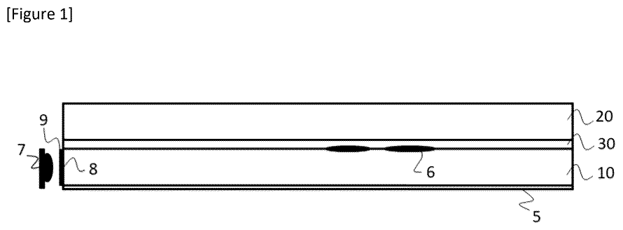

The glazing unit consists of two sheets of glass or substrate. The lower substrate 10 faces the interior of the passenger compartment or building, and the upper substrate 20 faces the exterior of the passenger compartment or building. The two substrates 10, 20 are separated by a PVB-type lamination interlayer 30. The various substrate faces are numbered conventionally from outside to inside, 1, 2, 3, 4. In FIG. 1, a functional coating 5 is arranged on face 4. A light-extracting means 6 is arranged on face 3, in the form of a patterned layer.

A light-emitting diode 7 is depicted schematically. Its emitting surface faces the edge face 8 of the lower substrate 10. A polarizer 9 is positioned between the emitting surface of diode 7 and the edge face 8 of the lower substrate 10.

### Implementation Examples

### 1. Materials and Functional Coatings

In these examples, the glass substrates are aluminosilicate glass substrates.

The laminating interlayers are 0.76 mm Poly(vinyl butyral) (“PVB”) interlayers.

The functional coatings comprise a functional layer located between two dielectric coatings.

The functional layers (F) are tin indium oxide layers.

The dielectric coatings comprise:
layers based on silicon nitride (Si3N4, n550=2.0),
layers based on silicon oxide (SiO2, n550=1.5).

The conditions for deposition of the layers, which were deposited by sputtering (“magnetron cathode” sputtering), are summarized in table 1.

TABLE 1

| | | Deposition | |
|---|---|---|---|
| Layer | Target used | pressure | Gas |
| ITO | In₂O₃ 90%, SnO₂ | 2.10⁻³ mbar | Ar/(Ar + O2) at |
| | 10% wt | | 99% |
| SiO2 | Si:Al (92:8% by wt) | 2.10⁻³ mbar | Ar/(Ar + O2) at |
| | | | 62.5% |
| Si3N4 | Si:Al (92:8% by wt) | 3.2*10⁻³ mbar | Ar/(Ar + N2) at |
| | | | 55% |

Rev. 1: This functional coating comprises the following sequence of layers: Glass//Si₃N₄ 30 nm/SiO₂ 17 nm/ITO 72 nm/Si₃N₄ 9 nm/SiO₂ 50 nm ITO stands for Indium Tin Oxide (InO₂:Sn)
Rev. 2: Glass//Si₃N₄ 88 nm/SiO₂ 150 nm/ITO 75 nm/Si₃N₄ 68 nm/SiO₂ 200 nm

The layer thicknesses of this coating have been chosen to optimize optical properties when using an S-type polarizer.

Rev. 3: Glass//Si₃N₄ 68 nm/SiO₂ 128 nm/ITO 75 nm/Si₃N₄ 5 nm

The layer thicknesses of this coating have been chosen to optimize optical properties when using an P-type polarizer.

### 2. Description of Luminous Laminated Glazing Units Tested

The laminated glazing units tested comprise:
a first 2 mm ordinary soda-lime glass substrate, and
a second 2 mm soda-lime glass substrate,
the two substrates are separated by a 0.76 mm Polyvinyl Butyral (PVB) lamination interlayer,
the functional coating is located on the first substrate and positioned on face 4.

The first substrate according to the invention is the substrate located furthest inside the passenger compartment or building.

The first substrate further comprises a patterned diffusing layer element (6) on face 3.

A polarizer film 9 marketed by Spechtech was used. This is a linear polarizing laminate film. It belongs to the category of absorbent polymer polarizers. Its features include:
a thickness of about 0.43 mm,
an extinction coefficient of about 44:1,
a transmission factor of 38% for unpolarized light in the 400 to 700 nm wavelength range.

It can be attached to the latter by any means, in particular by gluing or mechanical means.

The light source 8 is a white LED lamp capable of injecting light into the first substrate from the edge face. Light therefore first passes through the polarizer before entering the first substrate. The input face is therefore the substrate edge face.

### III. Characterization of the Guided-Mode Absorption Effect

Simulations were carried out on laminated luminous glazing units coated on face 4 with the low-emissivity functional coatings defined above.

The simulation calculates the change in the light beam, in polarized or unpolarized light, after reflection on the surface of the functional coating. In particular, it calculates light reflection and absorption at all wavelengths. By estimating these levels, it is possible to predict the brightness and color of the light extracted by the extractor elements at any point on the glazing unit.

The parameters Rgm, a*gm and b*gm correspond to the reflections and colors a* and b* in guided-mode reflection at the substrate/functional coating interface at an angle of 80° in the glass substrate.

Light absorption characteristics are obtained by simulation considering illuminant D65 at 80° perpendicular to the mounted material, and after reflection on the functional coating of the glass interior in single-glazed or laminated glass (unless otherwise indicated):
AL corresponds to light absorption in the visible range in %,
a*abs and b*abs correspond to the absorption colors a* and b* by the coating
L*a*b*observer inside the glass.

They are summarized in the table below.

| | | Ex. 1 | Ex. 2 | Ex. 3 |
|---|---|---|---|---|
| coating | | Rev. 1 | Rev.2 | Rev.3 |
| With s-type | Rgm (%) | 94.1 | 99.2 | 96.6 |
| polarizer | a*gm | −2.4 | −0.2 | −6.7 |
| | b*gm | −1.5 | 0.4 | 18.2 |
| | AL (%) | 5.9 | 0.1 | 3.4 |
| | a*abs | 13.9 | 3.4 | 47.4 |
| | b*abs | 11.1 | 0.6 | −65.6 |
| With p-type | Rgm (%) | 88.2 | 96.6 | 98.2 |
| polarizer | a*gm | −5.5 | −3 | −0.7 |
| | b*gm | −5 | −0.2 | 1 |
| | AL (%) | 11.8 | 4.5 | 1.9 |
| | a*abs | 19.1 | 39.7 | 7.5 |
| | b*abs | 25.6 | 37.6 | 6.1 |
| without | Rgm (%) | 91.1 | 97.7 | 97.4 |
| polarizer | a*gm | −3.9 | −3.2 | −3.6 |
| | b*gm | −3.2 | −1.4 | 8.4 |
| | AL (%) | 8.9 | 2.3 | 2.6 |
| | a*abs | 16.9 | 31.7 | 32.5 |
| | b*abs | 19.4 | 25.8 | −45.4 |

The values Rgm, a*gm and b*gm in guided-mode reflection at the substrate/functional coating interface were determined. This reflection corresponds to an angle of incidence of 80° in the glass substrate.

By definition of the guided mode, whose propagation angle is greater than the system's critical angle, light cannot be transmitted through the coating. What is not reflected is therefore absorbed.

According to the invention, it is very useful to have as high an Rgm as possible, as this parameter denotes low absorption. Indeed, conserving the energy of a guided mode requires that Rgm+Agm=1, where Agm is the absorption of the guided mode. Low absorption results in high Rgm values. A higher Rgm value reflects both lower absorption, particularly in the red in the guided mode, and better preservation of the guided mode in terms of its total intensity.

The parameters a*gm and b*gm indicate the change in the colorimetric parameters of the light on reflection, for a white incident light, of the Illuminant D65 type.

A positive a*gm means that the reflection becomes redder than the incident ray.

A negative a*gm means that the reflection becomes greener than the incident ray.

A positive b*gm means that the reflection becomes more yellow than the incident ray.

A negative b*gm means that the reflection becomes bluer than the incident ray.

A reflection of a certain color indicates light absorption of the complementary color. So, for example, a negative a*gm means green reflection and red absorption.

The higher the absolute values of a* and b*, the more pronounced the color of the reflections/absorptions.

According to the invention, less negative or even neutral values of a*gm and b*gm are sought.

However, this must be weighed against the Rgm values. As explained above, a high Rgm indicates low absorption. This is why it can be beneficial to have structures with high Rgm values even if the associated a*gm and b*gm are higher in absolute value, as these colors will be less intense.

It can be seen that for examples 1 and 2, optical properties and colors are improved with the use of an S-type polarizer, compared to the optical properties and colors obtained without a polarizer. Light reflection is increased and light absorption is reduced. Colors are more neutral (closer to zero).

In Example 3, optical properties and colors are enhanced by the use of a P-type polarizer.

Depending on the coating used, it is advisable to choose a type of polarizer to enhance the intensity and color of the light pattern.

The invention is also applicable to other glazing structures, such as single or double glazing units.

In the case of single-glazing, the critical angle of total internal reflection is no longer 80° but around 40°

Other coatings could be used, with or without low-emissivity properties.

Other positions can be envisaged for the coating and extractor elements. For example, the coating can be placed on face 3 and the extractor elements on face 4.

When using RGB LEDs, it may be possible to place the polarizer in front of the red light emission only. This arrangement would have the advantage of further reducing color variation and increasing light output.

1. A luminous glazing unit comprising:
a first substrate with a functional coating, said first substrate having two faces and an edge face,
a light source comprising an emitting surface, optically coupled with the first substrate so that light enters the first substrate via an input face and the first substrate forms a light guide,
a light-extracting element for extracting light and forming a light pattern, and
at least one light polarizer located between the emitting surface of the light source and the light input face in the first substrate.

2. The luminous glazing unit according to claim 1, wherein the light input face into the first substrate is the first substrate edge face.

3. The luminous glazing unit according to claim 1, wherein the first substrate has a hole and the light input face into the first substrate is a wall delimiting the hole.

4. The luminous glazing unit according to claim 1, wherein the light source is an inorganic light-emitting diode.

5. The luminous glazing unit according to claim 1, wherein the first substrate is coated with a low-emissivity functional coating.

6. The luminous glazing unit according to claim 5, wherein the low-emissivity coating comprises a layer of transparent conductive oxide.

7. The luminous glazing unit according to claim 1, wherein the polarizer is an S-type polarizer.

8. The luminous glazing unit according to claim 1, wherein the polarizer is a P-type polarizer.

9. The glazing unit according to claim 1, wherein the polarizer is bonded to the emitting surface of the light source.

10. The glazing unit according to claim 1, wherein the polarizer is bonded to the light input face into the first substrate.

11. The glazing unit according to claim 1, wherein the emitting surface is spaced apart from the light input face into the first substrate.

12. The glazing unit according to claim 1, wherein the extractor element is a diffusing layer element.

13. The glazing unit according to claim 1, wherein the glazing unit is bent.

14. The glazing unit according to claim 1, wherein the glazing unit is a single glazing unit.

15. The glazing unit according to claim 1, further comprising a second glass substrate, spaced apart from the first substrate by a gas gap so as to form a double glazing unit.

16. The glazing unit according to claim 1, further comprising a second substrate and a lamination interlayer arranged between the first and second substrates to form a laminated glazing.

17. The glazing unit according to claim 16, wherein the glazing unit is mounted on a passenger compartment or a building, the different faces of the first and second substrates being numbered from 1 to 4 from the outside toward the inside of the passenger compartment or building.

18. The glazing unit according to claim 17, wherein the first substrate is located further inside the building or passenger compartment than the second substrate.

19. The glazing unit according to claim 17, wherein the extractor element is arranged on face 3 or 4.

20. The glazing unit according to claim 17, wherein the light input face into the first substrate is the edge face of the substrate coated with the functional coating.
